(19) United States
(12) Patent Application Publication
(10) Pub. No.: US 2015/0370441 A1
(43) Pub. Date: Dec. 24, 2015

(54) METHODS, SYSTEMS AND COMPUTER-READABLE MEDIA FOR CONVERTING A SURFACE TO A TOUCH SURFACE

(71) Applicant: Infosys Limited, Bangalore (IN)

(72) Inventors: Velamuri Venkata Ravi Prasad, Visakhapatnam (IN); Jagan Joguparthi, Bangalore (IN)

(21) Appl. No.: 14/725,125

(22) Filed: May 29, 2015

(30) Foreign Application Priority Data
Jun. 23, 2014 (IN) 3029/CHE/2014

(51) Int. Cl. G06F 3/0488; G06F 3/041; G06F 3/0484

(52) U.S. Cl. CPC G06F 3/0488; G06F 3/04842; G06F 3/0412

(57) ABSTRACT

This technology relates to a method and system for converting a surface into a touch surface. In accordance with a disclosed embodiment, the system shall include a vision engine, configured to capture a set of location co-ordinates of a set of boundary points on the surface. The system shall further include a drawing interface, configured to create a set of mesh regions on the surface; a hash table configured to store; a point co-ordinate of each point of a mesh region; and a reference location co-ordinate of the each point. Further the system shall include an interpretation engine, configured to analyze a position of a user object on the surface and trigger a screen event on the position based on predetermined criteria.

This application claims the benefit of Indian Patent Application No. 3029/CHE/2014 filed Jun. 23, 2014, which is hereby incorporated by reference in its entirety.

### FIELD

The invention relates generally to a method and system in touch screen technology. More specifically, the present invention relates to a method and system for converting a projected surface to a touch surface.

### BACKGROUND

Current technology to convert a flat surface such as a table or a wall, into an interactive touch surface involves usage of advanced depth sensing camera. The depth sensing camera is usually placed in front of the flat surface. For instance, if the flat surface is a table top, the depth sensing camera shall be placed on the ceiling, facing the table top. In another instance, where the flat surface is a projected screen, from a computer application, the depth sensing camera is usually placed in front of the projected screen, between the projected screen and the projector. When a user's movement of his finger, stylus or any object, on the flat surface occurs, the depth sensing camera can capture such movement. The movement is interpreted into one or more screen events, essential for making the flat surface a touch screen display.

A disadvantage of aforesaid positions of the depth sensing camera is the flat surface may get obscured when the user appears before the depth sensing camera. As a result, the movement that may occur, during an obscured occurrence, may not be captured by the depth sensing camera. Thus there is a need for a method and system, wherein the depth sensing camera is placed in position other than the aforesaid directions, such that each position of the user can be captured.

The alternate system and method must also interpret the movement of the object to a standard screen event of a mouse pointer of a computer screen. Thus a unique system and method for converting a flat surface to a touch screen is proposed.

### SUMMARY

This technology provides a method and system for converting a surface to a touch surface. In accordance with the disclosed embodiment, the method may include capturing a set of location co-ordinates of a set of boundary points on the projected surface. Further, the method may include creating a set of mesh regions from the set of boundary points and mapping a location co-ordinate of each point in a mesh region, to a reference location co-ordinate of the each point. Finally the method shall include the step of triggering a screen event at a position on the surface, based on predetermined criteria.

In an additional embodiment, a system for converting a surface to a touch surface is disclosed. The system shall include a vision engine, configured to capture a set of location co-ordinates of a set of boundary points on the surface. The system shall further include a drawing interface, configured to create a set of mesh regions on the surface; a hash table configured to store; a point co-ordinate of each point of a mesh region; and a reference location co-ordinate of the each point. Further the system shall include an interpretation engine, configured to analyze a position of a user object on the surface and trigger a screen event on the position based on predetermined criteria.

These and other features, aspects, and advantages of the this technology will be better understood with reference to the following description and claims.

### BRIEF DESCRIPTION OF DRAWINGS

FIG. 1 is a flowchart illustrating an embodiment of a method for converting a surface to a touch surface.

FIG. 2 is a flowchart illustrating a preferred embodiment of a method for converting a surface to a touch surface.

FIGS. 3A and 3B show exemplary systems for converting a surface to a touch surface.

FIG. 4 illustrates a generalized example of a computing environment 400.

While systems and methods are described herein by way of example and embodiments, those skilled in the art recognize that systems and methods for converting a surface to a touch surface, is not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include”, “including”, and “includes” mean including, but not limited to.

### DETAILED DESCRIPTION

Disclosed embodiments provide computer-implemented methods, systems, and computer-program products for converting a surface to a touch surface. More specifically the methods and systems disclosed employ a sensor to capture a movement of an object on the surface and to interpret an action of the object into a standard screen event of a typical computer application. The sensor can be an available depth sensing camera such as Kinect developed by Microsoft Incorporation, USA.

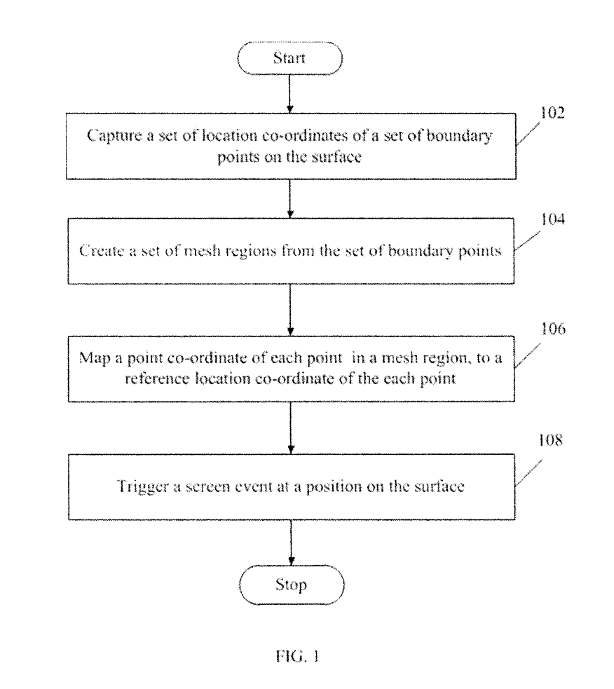

FIG. 1 is a flowchart that illustrates a method performed in converting a surface to a touch surface in accordance with an embodiment of this technology. At step 102, a set of location co-ordinates of a set of boundary points on the surface can be captured. The set of location co-ordinates is usually measured with respect to a sensor located in a perpendicular direction of the surface. In an embodiment, the set of location co-ordinates can refer to a set of the kinect co-ordinates where the kinect is the sensor in such embodiment. The sensor is capable of tracking a user and a predefined user interaction. Further, the set of boundary points can be captured by a predefined user interaction with the surface. In an instance, a user may place a finger or an object, on a point on the surface and utter a predefined word such as ‘capture’, signifying to an embedded vision engine to capture to the point as a boundary point. It could also be a simple gesture like raising a hand above shoulder to trigger the embedded vision engines. Further, at step 104, a set of mesh regions can be created from the set of boundary points. Each mesh region can basically include a subset area of the surface, such that the each mesh region shall include a subset of points of the surface. A point co-ordinate of each point in a mesh region can be mapped to a reference location co-ordinate of the each point, at step 106. In an embodiment, the reference location co-ordinates may refer to a computer resolution co-ordinate. The point co-ordinate of the each point is usually measured with respect to the sensor, and the reference location co-ordinate basically signifies a resolution of the surface. In an instance, the resolution of the surface can be 1024*768 pixels, indicating a total number of points required to represent the surface. The reference location co-ordinate of the each point can be a pixel as per a resolution of a computer screen projected on the surface.

Finally, based on predetermined criteria, at step 108, a screen event can be triggered at a position on the surface, when an object interacts with the surface at the position. The screen event can include a single click mouse event, a double click mouse event or a drag operation, performed on a computer screen. The predetermined criteria can include, a movement of the object at the position; and time duration of contact of the object with the surface. For instance a touch at a point greater than a time threshold and object is removed from touch vicinity a double click is inferred. In one of the embodiments the time threshold may be 0.5 sec. If the object is in contact with the surface for a time greater than a threshold and there is movement with continued touch, a determination of the drag operation can be made. If there is a touch and quickly the object is removed from the vicinity, a single click is inferred.

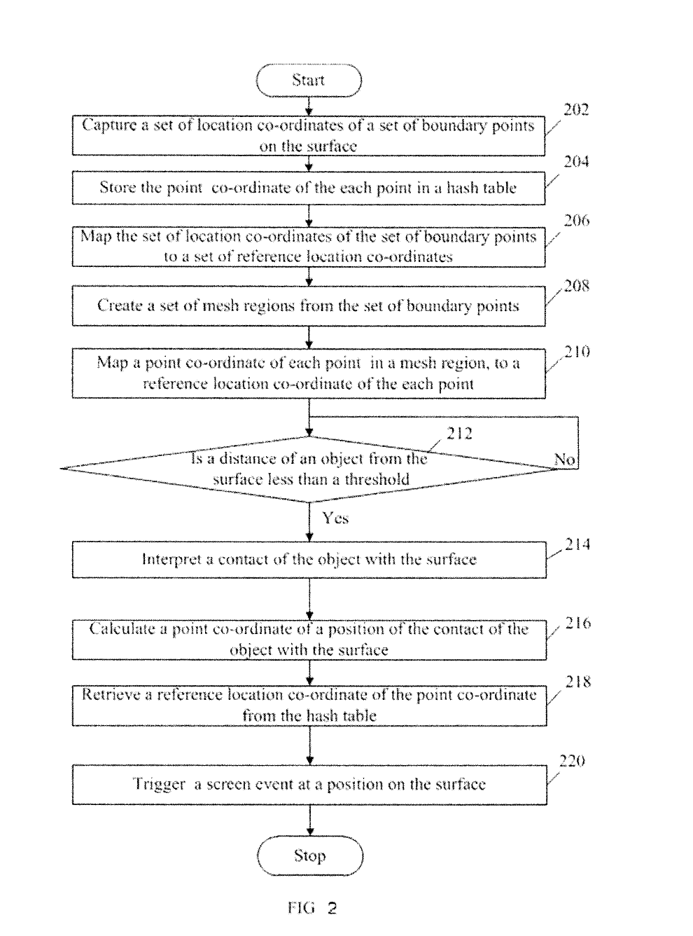

FIG. 2 illustrates an alternate embodiment of a method of practicing this technology. At step 202, a set of location co-ordinates of a set of boundary points on the surface can be captured via a predefined user interaction with the surface. A location co-ordinate is usually measured with respect to a sensor located in a perpendicular direction of the surface. The sensor can be a device for sensing a movement of a user in a line of sight of the sensor. In an instance the Kinect developed by Microsoft Incorporation may be used for the sensor. In one embodiment the sensor may be placed perpendicular to the surface and is able to track a predefined user interaction. In the instance, the set of location co-ordinates can be a set of the kinect co-ordinates. The set of boundary points, shall define area of the surface, intended to be converted into a touch screen. At step 204, location co-ordinate of each point of the set of boundary points can be stored in a hash table. At step 206, the set of location co-ordinates of the set of boundary points can be mapped to a set of reference location co-ordinates, where the reference location co-ordinates signify a resolution of the surface. In an embodiment, the set of reference location co-ordinates may refer to a set of computer resolution co-ordinates of a computer.

Further, a set of mesh regions can be created from the set of boundary points, at step 208. A point co-ordinate of each point of a mesh region can be mapped to a reference location co-ordinate of the each point, by a lookup procedure on the hash table, at step 210. The hash table may include a memory hash table that can store the location co-ordinate of the each point of the surface against the reference location co-ordinate of the each point. In the disclosed embodiment, the reference location co-ordinate of the each point is a pixel as per a resolution of a computer screen of the computer that is usually projected on the surface.

Further, at step 212, a determination of a contact of the object with the surface is made. In an event a distance of the object from the surface is less than a threshold, the contact of the object with the surface can be interpreted, at step 214. In an event the object is at a distance greater than the threshold, the object may not be interpreted to make the contact with the surface. A point co-ordinate of a position of the contact of the object with the surface can be calculated at step 216, by a series of algorithms. At step 218, a reference location co-ordinate of the point co-ordinate can be retrieved from the hash table. When a map of the point co-ordinate does not exist in the hash table, then a nearest reference location co-ordinate to the point co-ordinate can be determined by a running a set of nearest point determination algorithms. In an embodiment, one of the series of algorithm for calculating point co-ordinate may include receiving of frames from the kinect device. Each of the received frame is a depth map that may be described as co-ordinate representing depth image resolution (x, y) and the depth value (z). The co-ordinates of each point (x, y, z) in a frame are stored in a hash table. The mesh regions may totally be constructed through simple linear extrapolation and is stored in the hash table. In another embodiment, one of the nearest point determination algorithm may be used to calculate the nearest reference location co-ordinate which includes checking the all the depth points in a frame whose x, y, and z coordinate falls within the four corners of the touch surface. This is done by computing the minimum value of x, minimum value of y and minimum value of z from the data of the four corners of the surface. Similarly the maximum value of x, maximum value of y and maximum value of z are computed from the four corner values of the surface. This would give a set of points whose x, y, z fall within the minimum and maximum values of x, y, z of the corners of the touch surface. If there are no points after this computation it implies that there is no object near the touch surface. If there are one or more points after this computation then it implies that there is an object within the threshold distance from the touch surface. From this set of points, those points which do not have a corresponding entry in the hash table are filtered out. From the filtered set of points the one value of x that occurs max number of times in the given depth map and whose distance from surface is below another threshold value is selected. The same selection process is repeated for y and z. This point x, y, z is selected and is matched in the hash table. The corresponding point from the hash table is extracted and is treated as the point of touch. A touch accuracy up to fifteen millimeter by fifteen millimeter of the touch surface can be achieved.

Further based on a predetermined criteria, a screen event can be triggered at the position on the surface, at step 220. The predetermined criteria may include a movement of the object at the position; and time duration of the contact of the object with the surface. Further, the screen event may include a single click mouse event, a double click mouse event or a drag operation on a standard computer screen.

In alternate embodiments, the surface can be a LCD screen, a rear projection or a front projection of a computer screen, a banner posted on a wall, a paper menu and the like. In an alternate embodiment, where the surface is the banner is posted on the wall, a set of dimensions of the banner and a plurality of information of the banner can be stored within a computer. When the user touches an image or a pixel co-ordinate on the banner, the Kinect can detect the position, and a relevant event on the pixel co-ordinate or on the image as configured may be fired. In an instance, where the banner is a hotel menu card, when the user points on a particular icon signifying a menu item, the computer can be programmed, to place an order for the menu item.

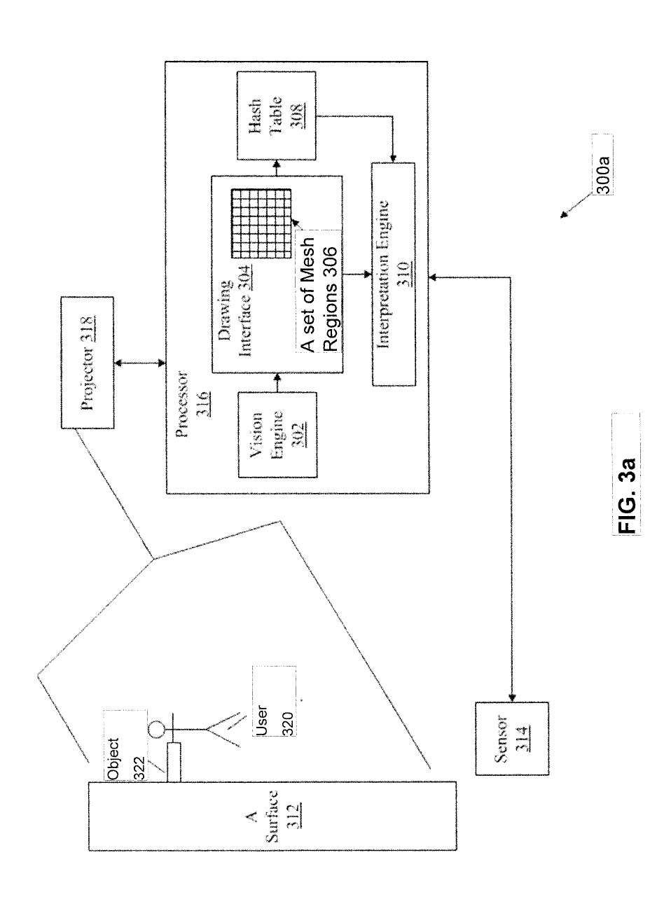

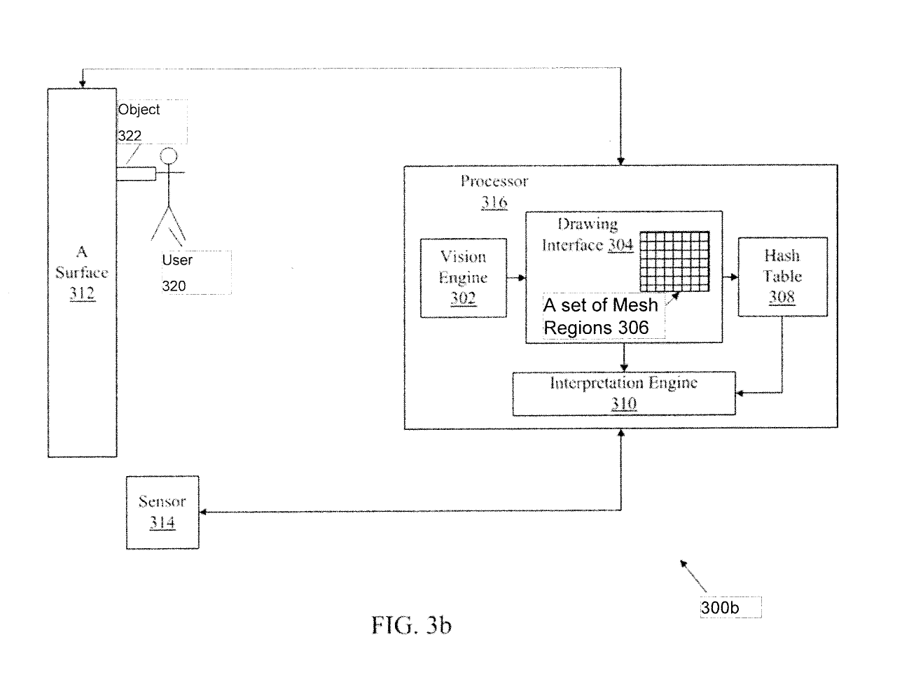

FIG. 3A illustrates an exemplary system or surface conversion computing device 300a in which various embodiments of this technology can be practiced. The system comprises of a vision engine 302, a drawing interface 304, a hash table 308, an interpretation engine 310, a sensor 314, a surface 312, a projector 318 and a processor 316. A processor 316, can include the vision engine 302, the drawing interface 304, the hash table 308, and the interpretation engine 310. Further, the processor 316 can be communicatively coupled with the sensor 314, and a projector 318 that is placed facing the surface 312.

The vision engine 302, is configured to capture a set of boundary points of the surface 312, when a user 320, interacts with the surface 312, via an object 322, in a predefined manner The predefined manner may include the user 320, placing the object 322 on the surface 312 on the set of boundary points and uttering a word such as “capture” on each boundary point. The set of boundary points shall define an area of the surface, to be converted into a touch screen surface. The object 322, can be a finger of the user 320, a stylus or any other material, that maybe used by the user 320, for performing an interaction with the surface 312. The drawing interface 304, can be configured to draw a set of mesh regions from the captured set of boundary points. Further, the hash table 308, can be configured to store a point co-ordinate of each point of a mesh region and a reference location co-ordinate of the each point. The point co-ordinate is usually measured with respect to the sensor 314, whereas the reference location co-ordinate is usually measured in reference to the resolution of the surface 312.

The interpretation engine 310, can be configured to interpret an interaction of the object 322 with the surface 312, as a standard screen event. Based on a distance of the object 322, from the surface 312, the interpretation engine 310, can determine whether the object 322, shall make a contact with the surface 312. In an instance, if the object 322, is at a distance less than a predetermined threshold. In one of the embodiment the threshold of distance may be 2 centimeters at a particular location of the screen. Other location may have a lesser threshold for the same setup. The interpretation engine 310 may interpret that the object 322 contacted with the surface 312. Further, the interpretation engine 310, can detect a position at which the object 322, makes the contact with the surface 312. Further, a point co-ordinate of a point at the position can be fetched from the sensor 314. The reference location co-ordinate of the point co-ordinate can be retrieved from the hash table 308. The interpretation engine 310, can be configured to determine a nearest reference location co-ordinate to the point co-ordinate, when a map of the point co-ordinate is absent in the set of reference location co-ordinates. The interpretation engine 310 can be further configured to trigger a screen event on the position based on predetermined criteria. The predetermined criteria may include a movement of the object 322 at the position; and time duration of the contact of the object 322 with the surface. The screen event can include a standard screen event such as a single click mouse event, a double click or a drag operation. For instance, if the time for which the object 322 is in contact with the surface 312 is greater than a time threshold and object is removed from touch vicinity a double click is inferred, and the screen event triggered can be a double click screen event. If the object is in contact with the surface for a time greater than a threshold and there is movement with continued touch, a determination of the drag operation can be made. If there is a touch and quickly the object is removed from the vicinity, a single click is inferred. The reference location co-ordinate of the each point can be a pixel as per a resolution of a computer screen projected on the surface.

In the disclosed embodiment, the surface is a front projection of a computer screen, where the projector 318, is placed in front of the surface 312. In an alternate embodiment, the surface may be a rear projection of the computer screen, where the projector 318, can be placed in a rear direction of the surface 312. In another embodiment, the surface can be an image mounted on a wall, such as a banner containing menu items displayed to a user at a shopping area.

In yet another embodiment of the system or surface conversion computing device, as illustrated in FIG. 3b, the surface 312, can be a LED screen, communicatively coupled with the processor 318. In the disclosed embodiment, the sensor 314, can be communicatively coupled with the processor 318. The vision engine 302, the drawing interface 304, the hash table 308, and the interpretation engine 310 can be coupled within the processor 318, required for converting the surface 312, into a touch screen area. The implementation and working of the system may differ based on an application of the system. In an embodiment, where the surface is a banner posted on a wall, the dimensions of the banner can be stored within a memory of the processor 318. When the user touches a point on the banner, point-co-ordinates of the point shall be communicated to the processor 318, the vision engine 302, the hash table 308, and the interpretation engine 310, shall perform functions as described in aforementioned embodiments.

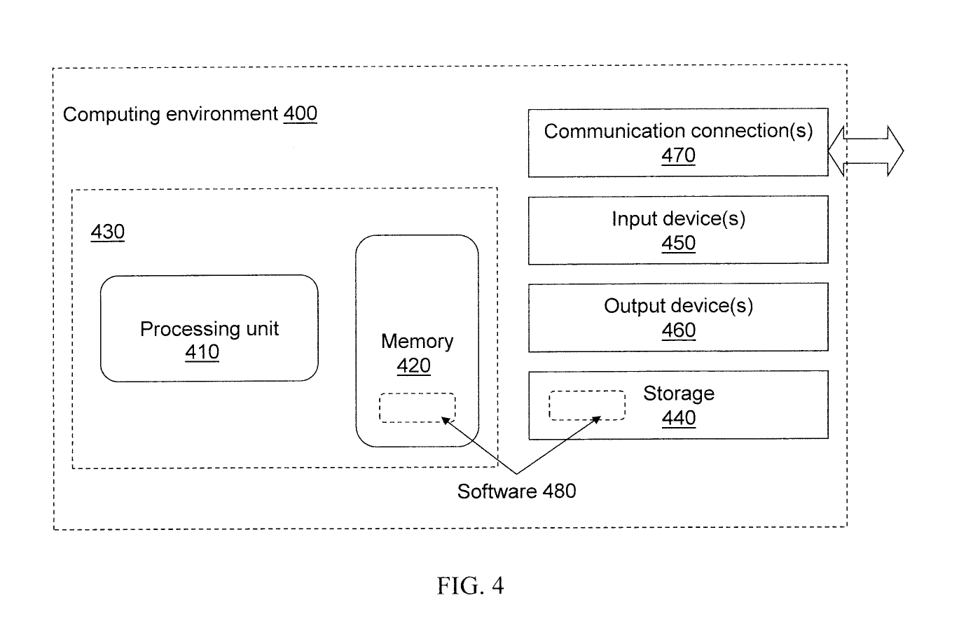

One or more of the above-described techniques can be implemented in or involve one or more computer systems. FIG. 4 illustrates an example of a computing environment 400, one or more portions of which can be used to implement the surface conversion computing device. The computing environment 400 is not intended to suggest any limitation as to scope of use or functionality of described embodiments.

With reference to FIG. 4, the computing environment 400 includes at least one processing unit 410 and memory 420. In FIG. 4, this most basic configuration 430 is included within a dashed line. The processing unit 410 executes computer-executable instructions and may be a real or a virtual processor. In a multi-processing system, multiple processing units execute computer-executable instructions to increase processing power. The memory 420 may be volatile memory (e.g., registers, cache, RAM), non-volatile memory (e.g., ROM, EEPROM, flash memory, etc.), or some combination of the two. In some embodiments, the memory 420 stores software 480 implementing described techniques.

A computing environment may have additional features. For example, the computing environment 400 includes storage 440, one or more input devices 440, one or more output devices 460, and one or more communication connections 470.

An interconnection mechanism (not shown) such as a bus, controller, or network interconnects the components of the computing environment 400. Typically, operating system software (not shown) provides an operating environment for other software executing in the computing environment 400, and coordinates activities of the components of the computing environment 400.

The storage 440 may be removable or non-removable, and includes magnetic disks, magnetic tapes or cassettes, CD-ROMs, CD-RWs, DVDs, or any other medium which can be used to store information and which can be accessed within the computing environment 400. In some embodiments, the storage 440 stores instructions for the software 480.

The input device(s) 450 may be a touch input device such as a keyboard, mouse, pen, trackball, touch screen, or game controller, a voice input device, a scanning device, a digital camera, or another device that provides input to the computing environment 400. The output device(s) 460 may be a display, printer, speaker, or another device that provides output from the computing environment 400.

The communication connection(s) 470 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 400, computer-readable media include memory 420, storage 440, communication media, and combinations of any of the above.

Having described and illustrated the principles of this technology with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The following description is presented to enable a person of ordinary skill in the art to make and use this technology and is provided in the context of the requirement for a obtaining a patent. The present description is the best presently-contemplated method for carrying out this technology. Various modifications to the preferred embodiment will be readily apparent to those skilled in the art and the generic principles of this technology may be applied to other embodiments, and some features of this technology may be used without the corresponding use of other features. Accordingly, the present invention is not intended to be limited to the embodiment shown but is to be accorded the widest scope consistent with the principles and features described herein.

While the foregoing has described certain embodiments and the best mode of practicing this technology, it is understood that various implementations, modifications and examples of the subject matter disclosed herein may be made. It is intended by the following claims to cover the various implementations, modifications, and variations that may fall within the scope of the subject matter described.

What is claimed is:

1. A method of touch surface conversion, the method comprising:
capturing, by a surface conversion computing device, a set of location co-ordinates of a set of boundary points on a surface;
creating, by the surface conversion computing device, a set of mesh regions from the set of boundary points;
mapping, by the surface conversion computing device, a point co-ordinate of each of a plurality of points in each of the mesh regions to a reference location co-ordinate; and
triggering, by the surface conversion computing device, a screen event at a position on the surface in response to an interaction of an object at the position on the surface, wherein the position corresponds to at least one of the point co-ordinates and the screen event is based on predetermined criteria.

2. The method of claim 1, wherein the location co-ordinate are measured with respect to a sensor located perpendicular to the surface that is configured to be capable of tracking at least one predefined user interaction with the surface and the set of boundary points is obtained in response to the predefined user interaction.

3. The method of claim 1, further comprising:
storing the point co-ordinate of the each of the points in a hash table; and
mapping the set of location co-ordinates of the set of boundary points to a set of reference location co-ordinates, wherein the set of mesh regions is within the set of boundary points.

4. The method of claim 1, wherein:
the reference location co-ordinate of the each of the points corresponds to a pixel and is based on a resolution of a computer screen projected on the surface; and
the surface is a liquid crystal display (LCD) screen, a rear projection of a computer screen, a front projection of a computer screen, or a paper image mounted on a wall.

5. The method of claim 1, wherein the interaction is identified when a determined distance of the object from the surface is less than a threshold and the screen event comprises a single click mouse event, a double click mouse event, or a drag operation.

6. The method of claim 1, wherein the predetermined criteria comprises a movement of the object at the position or a time duration of the interaction of the object with the surface.

7. A non-transitory computer readable medium having stored thereon instructions for touch surface conversion comprising executable code which when executed by at least one processor, causes the processor to perform steps comprising:
capturing a set of location co-ordinates of a set of boundary points on a surface;
creating a set of mesh regions from the set of boundary points;
mapping a point co-ordinate of each of a plurality of points in each of the mesh regions to a reference location co-ordinate; and
triggering a screen event at a position on the surface in response to an interaction of an object at the position on the surface, wherein the position corresponds to at least one of the point co-ordinates and the screen event is based on predetermined criteria.

8. The non-transitory computer readable medium as set forth in claim 7, wherein the location co-ordinate are measured with respect to a sensor located perpendicular to the surface that is configured to be capable of tracking at least one predefined user interaction with the surface and the set of boundary points is obtained in response to the predefined user interaction.

9. The non-transitory computer readable medium as set forth in claim 7, wherein the executable code, when executed by the processor, further causes the processor to perform at least one additional step comprising:
storing the point co-ordinate of the each of the points in a hash table; and
mapping the set of location co-ordinates of the set of boundary points to a set of reference location co-ordinates, wherein the set of mesh regions is within the set of boundary points.

10. The non-transitory computer readable medium as set forth in claim 7, wherein:
the reference location co-ordinate of the each of the points corresponds to a pixel and is based on a resolution of a computer screen projected on the surface; and
the surface is a liquid crystal display (LCD) screen, a rear projection of a computer screen, a front projection of a computer screen, or a paper image mounted on a wall.

11. The non-transitory computer readable medium as set forth in claim 7, wherein the interaction is identified when a determined distance of the object from the surface is less than a threshold and the screen event comprises a single click mouse event, a double click mouse event, or a drag operation.

12. The non-transitory computer readable medium as set forth in claim 7, wherein the predetermined criteria comprises a movement of the object at the position or a time duration of the interaction of the object with the surface.

13. A surface conversion computing device comprising at least one processor and a memory coupled to the processor which is configured to be capable of executing programmed instructions comprising and stored in the memory to:
capture a set of location co-ordinates of a set of boundary points on a surface;
create a set of mesh regions from the set of boundary points;
map a point co-ordinate of each of a plurality of points in each of the mesh regions to a reference location co-ordinate; and
trigger a screen event at a position on the surface in response to an interaction of an object at the position on the surface, wherein the position corresponds to at least one of the point co-ordinates and the screen event is based on predetermined criteria.

14. The surface conversion computing device as set forth in claim 13, wherein the location co-ordinate are measured with respect to a sensor located perpendicular to the surface that is configured to be capable of tracking at least one predefined user interaction with the surface and the set of boundary points is obtained in response to the predefined user interaction.

15. The surface conversion computing device as set forth in claim 13, wherein the processor coupled to the memory is further configured to be capable of executing at least one additional programmed instruction to:
store the point co-ordinate of the each of the points in a hash table; and
map the set of location co-ordinates of the set of boundary points to a set of reference location co-ordinates, wherein the set of mesh regions is within the set of boundary points.

16. The surface conversion computing device as set forth in claim 13, wherein:
the reference location co-ordinate of the each of the points corresponds to a pixel and is based on a resolution of a computer screen projected on the surface; and
the surface is a liquid crystal display (LCD) screen, a rear projection of a computer screen, a front projection of a computer screen, or a paper image mounted on a wall.

17. The surface conversion computing device as set forth in claim 13, wherein the interaction is identified when a determined distance of the object from the surface is less than a threshold and the screen event comprises a single click mouse event, a double click mouse event, or a drag operation.

18. The surface conversion computing device as set forth in claim 13, wherein the predetermined criteria comprises a movement of the object at the position or a time duration of the interaction of the object with the surface.
